(19) United States
(12) Patent Application Publication
(10) Pub. No.: US 2025/0242367 A1
(43) Pub. Date: Jul. 31, 2025

(54) LIQUID DISPENSER

(71) Applicant: Aptar Radolfzell GmbH, Radolfzell (DE)

(72) Inventors: Jürgen GREINER-PERTH, Gottmadingen (DE); Stefan RITSCHE, Eigeltingen (DE)

(21) Appl. No.: 18/729,656

(22) PCT Filed: Jan. 8, 2022
(86) PCT No.: PCT/EP2022/051003

§ 371 Date: Jul. 17, 2024

(51) Int. Cl. B05B 11/00; B65D 47/18; B65D 47/20; B65D 47/32

(52) U.S. Cl. CPC B05B 11/0032; B65D 47/18; B65D 47/2056; B65D 47/32; B65D 2205/025

(57) ABSTRACT

A liquid dispenser including a liquid reservoir, a bottle body and a delivery head fastened to the bottle body and having a delivery opening. The liquid dispenser additionally includes a protective cap attachable to the delivery head and having at least one ventilation opening and a cap interior. Ambient air flows into the cap interior through the ventilation opening when the protective cap is in an attached state. The liquid dispenser includes a removable closure element having a shipping state preventing ambient air from traveling through the at least one ventilation opening to the delivery opening. The delivery head has an upper annular face and an applicator neck having an outside and the protective cap is held on the outside of the applicator neck in the attached state. The applicator neck has an elongate shape with a cylindrical shell face and an end face penetrated by the delivery opening.

### FIELD OF APPLICATION AND PRIOR ART

The invention relates to a liquid dispenser for dispensing liquids, in particular for dispensing pharmaceutical or cosmetic liquids.

A liquid dispenser of the generic type possesses a liquid reservoir for receiving liquid prior to delivery, and a delivery head having a delivery opening through which the liquid can be dispensed when required. The user can impinge liquid from the liquid reservoir with pressure by means of a pump device or another mechanism, and as a result dispense said liquid through the delivery opening.

It is known that such liquid dispensers can have a protective cap which is removable for the purpose of dispensing liquid and in the attached state mechanically protects the delivery opening. In order to nevertheless enable rapid drying of potentially remaining liquid remnants, such a cap may possess at least one ventilation opening through which ambient air can flow into a cap interior when the protective cap is in the attached state.

A protective cap of this type is known from DE 10 2013 226 250 A1. The ventilation openings of the caps proposed herein have a shell face having a substantially consistent external diameter and an end side, whereby the ventilation openings are provided in the shell face or the end side.

In order to prevent the ingress of contaminations and bacteria until the liquid dispenser is put to use, it is proposed in the mentioned document to keep the ventilation openings closed until being put to use by means of an adhesive tape or by means of a portion that is integrally connected to the cap. The ventilation openings are opened only when the liquid dispenser is put to use, so as to allow ventilation of the delivery opening during a phase in which the liquid dispenser is in use.

### OBJECT AND SOLUTION

It is an object of the invention to refine a generic liquid dispenser with a view to improving the implementation of a ventilated protective cap.

Proposed according to the invention for this purpose is a liquid dispenser which in the usual generic manner has a liquid reservoir for receiving liquid prior to delivery, and a delivery head having a delivery opening.

The liquid reservoir is defined by a bottle body. The bottle body can particularly preferably be a squeeze bottle body, thus a bottle body of plastics material, which can be compressed counter to a restoring force in order to impinge the liquid in the liquid reservoir with pressure, and to hereby deliver said liquid. For example, polyethylene can be considered as a material for such a bottle body. Alternatively, rigid bottle bodies may also be used.

The liquid reservoir preferably has an internal volume of less than 20 ml, in particular an internal volume between 5 ml and 15 ml. In the shipping state, said liquid reservoir is filled with the liquid to be delivered, in particular with a pharmaceutical liquid. A liquid dispenser according to the invention can in particular be provided for ophthalmic applications, thus for applications into the eyes of the user. Accordingly, the liquid reservoir can be filled with an eye emulsion, in particular a cyclosporine eye emulsion.

The delivery head is fastened to the bottle body which surrounds the liquid reservoir, for example by means of a snap-fit connection or a threaded connection. An integral design is also possible in principle.

The delivery head has a base having an upper annular face on the outside, thus pointing away from the liquid reservoir, which is designed to be substantially flat. The coupling device for coupling to the bottle body is provided on this preferably cylindrical base.

The mentioned annular face surrounds an applicator neck which projects above the annular face. The applicator neck has an elongate and substantially cylindrical shape. A central axis of the applicator neck preferably extends coaxially with a central axis of the base and of the substantially flat annular face. A normal vector on the annular face, conjointly with the central axis of the applicator neck, encloses an angle of less than 20°.

The substantially cylindrical shape of the applicator neck is also understood to be a shape with a slight conicity. An applicator neck, the shell face of the latter from the proximal end at the level of the annular face to the distal end enclosing an angle of less than 10° in relation to a central axis of the applicator neck, is understood to be substantially cylindrical in the context of the invention.

An elongate shape is understood to mean that the length of the cylindrical applicator neck is larger than its mean diameter. The length is preferably at least 50% larger than the mean diameter.

The delivery opening is provided on the distal end of the applicator neck. Said delivery opening has a delivery direction which preferably is identical to the alignment of the central axis of the applicator neck.

The applicator neck, from its proximal end in the region of the annular face up to its distal end on which the delivery opening is provided, preferably has a length of at least 9 mm, particularly preferably a length of at least 12 mm. The maximum diameter of the applicator neck, which is preferably provided in the region of the proximal end of the latter, is preferably less than 8 mm, particularly preferably less than 6 mm. The external diameter of the annular face, or the external diameter of the base of the delivery head which is upwardly terminated by the annular face, is preferably between 15 mm and 20 mm. Particularly preferably, the maximum external diameter of the applicator neck is at most 40% of the external diameter of the annular face.

The delivery head, on its side pointing toward the liquid reservoir, has an inflow duct which is connected to the delivery opening, whereby at least one delivery valve or a conveying device such as a pump is preferably provided between the inflow duct and the delivery opening. In the case of a delivery valve, the latter can in particular be a delivery valve which opens as a function of pressure and which opens at a defined liquid pressure. In the absence of such a pressure, the outlet valve closes the delivery opening and in this way prevents the ingress of bacteria through the delivery opening. In particular, the delivery valve can possess a valve body having a valve plate and a valve pin which projects from the latter, whereby the valve plate is disposed below the annular face of the delivery head, and whereby the valve pin extends from the valve plate into the applicator neck.

In addition to the liquid duct leading from the inflow duct to the delivery opening, the delivery head can also have a ventilation duct through which air can flow into the liquid reservoir for replenishing the latter. The ventilation duct is preferably equipped with a ventilation valve and/or a filter for removing bacteria and contaminations.

A housing of the delivery head, or its applicator neck, is preferably made of plastics material, in particular of a polyolefin such as polypropylene (PP) or polyethylene (PE).

Various designs of liquid dispensers which are designed in the manner of the invention are possible, for instance liquid dispensers for delivering an atomized or non-atomized spray jet, for example. However, the design of the liquid dispenser according to the invention is particularly expedient in the case of a droplet dispenser. Such a droplet dispenser has an end face which is designed as a droplet-forming geometry on the distal end of the applicator neck. In the case of a downward-pointing delivery opening, liquid which is dispensed through the delivery opening accumulates on this droplet-forming geometry until the quantity of liquid is sufficient in order to release itself from the end face in the form of a droplet. The droplet-forming geometry can in particular be provided with a breakaway edge that delimits the end face on the outside.

The liquid dispenser according to the invention, for the purpose of delivering liquid, is provided with a removable protective cap which is attachable to the delivery head. The protective cap is able to be fastened on the outside of the annular face, and in particular on a base of the delivery head that terminates the annular face toward the top, in particular fastened by means of a friction-fitting clamping connection or by means of a form-fitting connection such as a threaded connection or a bayonet connection.

The protective cap has at least one ventilation opening through which ambient air can flow into a cap interior when the protective cap is in the attached state. In addition to the protective cap, a closure element which is removable when put to use and which prevents ambient air from being able to make its way through the at least one ventilation opening to the delivery opening prior to being put to use is provided. This closure element, which when putting to use the liquid dispenser is either completely removed from the protective cap or the liquid reservoir, or which is displaced relative to the protective cap in such a manner that it no longer closes the at least one ventilation opening, guarantees that no contaminations from the ambient air can make their way to the delivery opening until the liquid dispenser is put to use. The delivery opening is connected to the environment by way of the ventilation openings only after being put to use.

The applicator neck of a liquid dispenser according to the invention, which is significantly slimmer relative to the external diameter of the annular face, or the base, respectively, has substantial advantages in the context of a ventilated protective cap having a removable closure element. In particular, said applicator neck allows a plurality of possibilities for implementing a closure element, said possibilities being able to be implemented as mutual alternatives for the same delivery head. As a result, protective caps and closure elements of various types can be provided for the same delivery head, so as to be able to meet case-specific requirements or national regulatory frameworks. The various possibilities for designing the closure element are explained hereunder.

The protective cap preferably has two sub-regions with different cross sections, i.e. a coupling portion and a casing portion. The coupling portion of the protective cap, which forms the lower end in the attached state, has an internal cross section which is at least as large as an external contour of the annular face and which in the attached state rests on a shell region of the base of the delivery head that adjoins the annular face. The internal cross section of the coupling portion preferably has a circular shape.

Adjoining this coupling portion in the distal direction, thus pointing in the delivery direction, is the casing portion which has an internal cross section that tapers in a stepped manner relative to the coupling portion. The applicator neck in the attached state of the protective cap is disposed within the casing portion. The internal cross section of the casing portion can likewise have a circular shape. Preferred in comparison thereto is however a flattened shape of the casing portion, for example having an elliptic shape of the internal cross section. This can facilitate gripping of the protective cap and removal and attachment. It is furthermore advantageous for a terminating portion having an external contour that is enlarged relative to the casing portion to adjoin a distal end of the casing portion, so as to enable reliable gripping of the casing portion.

The at least one ventilation opening of the protective cap can in particular be provided on the casing portion and thereon penetrate the protective cap. For example, said ventilation opening can penetrate an end face that forms the distal end of the casing portion, or in particular be provided laterally on a shell face of the casing portion. Particular preferably, at least one ventilation opening is provided on the shell face of the casing portion and in the longitudinal direction of the dispenser so as to be approximately level with the delivery opening (+/−3 mm). As a result, particularly rapid drying of liquid remnants on the delivery opening is facilitated.

Disposing the at least one ventilation opening on the casing portion, which tapers relative to the coupling portion, is considered to be advantageous because the closure element which is to be removed prior to the liquid dispenser being put to use for the first time, or a gripping portion connected to said closure element, does not lead to any enlargement of the maximum diameter of the liquid dispenser. Such a gripping portion protrudes outward from the casing portion, but preferably does not protrude beyond the coupling portion in the radial direction.

The closure element can be formed by a tear-off element which is provided integrally on the protective cap, for example, which in the shipping state is connected in a materially integral manner to a periphery surrounding the ventilation opening and, for opening the ventilation opening, is removable from the protective cap by a tensile force. The integral connection between the periphery of the ventilation opening and the closure element can be achieved in that, for example, the closure element is produced conjointly with the protective cap and in particular the casing portion of the latter by a common injection-molding procedure, wherein separation lines between the closure element and the surrounding parts of the protective cap are preferably formed by regions of reduced wall thickness. It is also possible that the protective cap is initially produced with at least one open ventilation opening, and this ventilation opening is subsequently closed by means of a further injection-molding procedure that forms the closure element. In both cases, it is advantageous for a gripping portion of the type already mentioned to be provided, which is an integral part of the closure element.

Alternatively, the closure element can also be formed by a closure element which is designed in the form of an adhesive tape which is applied to the protective cap. This adhesive tape, which may simultaneously cover one or a plurality of ventilation openings, is preferably provided on the outside of the protective cap, so as to in particular completely or partially circumferentially surround the protective cap in the region of the tapered casing portion. Also provided in the case of such an adhesive tape is preferably a gripping portion which is provided at one end of the adhesive tape and can be gripped and impinged with a force for the purpose of removing the adhesive tape.

A further possibility for implementing the closure element provides that the latter is formed by an additional cap which is disposed in a cap interior of the protective cap and covers the delivery opening. In the case of such a design, it is thus possible that air flows in through the at least one ventilation opening of the protective cap already in the shipping state. However, due to the additional cap, the inflowing air cannot reach the delivery opening so that contamination of the delivery opening is effectively prevented.

When putting the dispenser to use, the user initially takes off the protective cap and then removes the additional cap. After the first use of the liquid dispenser, only the protective cap is then replaced while the additional cap is disposed of.

The additional cap can be secured on the delivery head in various ways prior to being used for the first time. A preferred design provides that the additional cap is held on the applicator neck per se. In particular, said additional cap can be held on the shell face of the applicator neck in a force-fitting manner. Clamping faces, in particular clamping ribs, can be provided on an internal side of the additional cap for this purpose. Alternatively, fixing to the applicator neck can also be performed in a form-fitting manner, in particular by means of an internal thread on an internal side of the additional cap, said internal thread in the shipping state resting on the outside on the applicator neck.

The additional cap can in the shipping state also be connected to the delivery head in a force-fitting of form-fitting manner on the annular face that surrounds the applicator neck by means of a coupling structure. Clearances in which the coupling structure of the additional cap engages can be provided in the annular face for this purpose. Alternatively, holding structures which conjointly with the additional cap form undercuts can be provided on the annular face. The clearances, or the holding structures, respectively, are preferably designed in such a manner that a dual movement is required for removing the additional cap, in particular comprising a rotating movement and a subsequent extraction movement, or compression of the additional cap and a subsequent extraction movement.

While an additional cap within the cap interior of the protective cap is considered to be advantageous, an additional cap or any other air-tight insulation layer which in the shipping state covers the protective cap and optionally also part of the delivery head, and as a result suppresses the air flow to the at least one ventilation opening, is also conceivable in principle.

Instead of the described closure elements which are separated from the liquid dispenser and disposed of when putting the liquid dispenser to use, the protective cap can also have a displaceable or rotatable segment as a closure element which is movable between a position that closes the ventilation opening and a position that releases the ventilation opening. The segment herein is preferably adapted to the protective cap in such a manner that a returning movement from the position releasing the ventilation opening back to the initial position is impossible or impeded. For this purpose, a latching edge can be provided in particular on the protective cap or on the segment, a latching portion engaging into said latching edge in the transfer to the releasing position and thus suppressing or impeding the return movement.

The displaceable or rotatable segment is preferably provided in the region of the tapered casing portion. In particular, said segment can surround the latter on the outside. It can be achieved as a result of the tapered design of the casing portion relative to the coupling portion that even the casing portion including the surrounding segment does not have a larger cross section than the coupling portion.

A further possible design of the closure element provides that the applicator neck in the shipping state is surrounded by a tubular casing which forms the closure element. The tubular casing is preferably made of an elastic plastics material. The casing is removed in the course of putting the liquid dispenser to use, and is preferably disposed of separately. Owing to the cylindrical shape of the applicator neck, the tubular casing maintains a seal without having to be under high tangential tension for this purpose.

The tubular casing rests in a sealing manner on the shell face of the applicator neck and is closed at a distal end in such a way that the delivery opening in the shipping state is effectively insulated in relation to the surrounding cap interior.

It can be provided that the tubular casing is pulled off or unrolled as an entity when putting the liquid dispenser to use, without said tubular casing being destroyed for this purpose. A gripping element for this purpose can be provided on the distal or proximal end of the casing. An alternative possibility provides that the tubular casing is intended to be irreversibly destroyed for the purpose of removal. In particular, the casing can have at least one predetermined breaking line with a reduced wall thickness for this purpose, in the region of which predetermined breaking line the casing is torn open according to the intended use. Two such predetermined breaking lines can preferably be provided, between which is provided a detachable opening strip of the casing. The opening strip is removed for the purpose of removing the casing, in particular in that a gripping portion at one end of the opening strip is gripped and pulled for this purpose. This has the effect that the opening strip opens the tubular casing while simultaneously tearing both predetermined breaking lines, so that the casing can subsequently be easily removed.

A tubular casing of the type described without predetermined breaking lines can in particular be formed in that the applicator neck in the shipping state is surrounded at least in the region of the delivery opening and in the region of a substantially cylindrical shell face of the applicator neck by a layer of lacquer, a plastics material or a wax, which forms the closure element.

Such a layer can in particular be applied in that the delivery head is partially submerged in a dipping bath of a liquid lacquer, of a liquid plastics material having a melting point that is lower in comparison to the material of the applicator neck, of a latex material, or of a liquid wax, in the course of production of the liquid dispenser. Polyurethane (PU), polyvinylchloride (PVC), polyethylene (PE), or a thermoplastic elastomer (TPE) can in particular be considered as plastics materials. The corresponding material forms a thin layer in the region of the applicator neck, which solidifies after removal from the dipping bath, thus forming the casing which is to be removed when first put to use. Instead of using a dipping bath, the layer can also be applied to the outside of the applicator neck by a spray procedure.

Sterilizing by means of radiation preferably takes place in the course of the production of the liquid dispenser and its delivery head. Should this be the case, the described procedure should be performed using a casing material which is not damaged by the corresponding radiation.

The removable closure element, in particular in the form of the described casing, can be produced from a material with antibacterial properties in order to offer additional protection in relation to bacteria.

### BRIEF DESCRIPTION OF THE DRAWINGS

Further advantages and aspects of the invention are derived from the claims and from the description hereunder of preferred exemplary embodiments of the invention, which are described hereunder by means of the figures.

FIGS. 1A and 1B show a delivery device of a liquid dispenser according to the invention, and the use of the latter by way of example.

FIG. 2 shows an exemplary embodiment of a liquid dispenser according to the invention, having a protective cap in which the delivery opening in the shipping state is protected by a casing.

FIGS. 3, 4 and 5A to 5C show further exemplary embodiments of a liquid dispenser according to the invention, having a protective cap in which the delivery opening in the shipping state is protected by casings of other types.

FIG. 6 shows an exemplary embodiment of a liquid dispenser according to the invention, having a protective cap in which the delivery opening in the shipping state is protected by means of an additional cap.

FIGS. 7 to 9 show further exemplary embodiments of a liquid dispenser according to the invention, having a protective cap in which the delivery opening in the shipping state is protected by additional caps of other types.

FIGS. 10A and 10B show an exemplary embodiment of a liquid dispenser according to the invention, having a protective cap in which the delivery opening in the shipping state is protected by means of a movable segment of the protective cap.

FIGS. 11 and 12 show further exemplary embodiments of a liquid dispenser according to the invention, having a protective cap in which the delivery opening in the shipping state is protected by means of a closure element which closes directly ventilation openings of the protective cap.

### DETAILED DESCRIPTION OF THE EXEMPLARY EMBODIMENTS

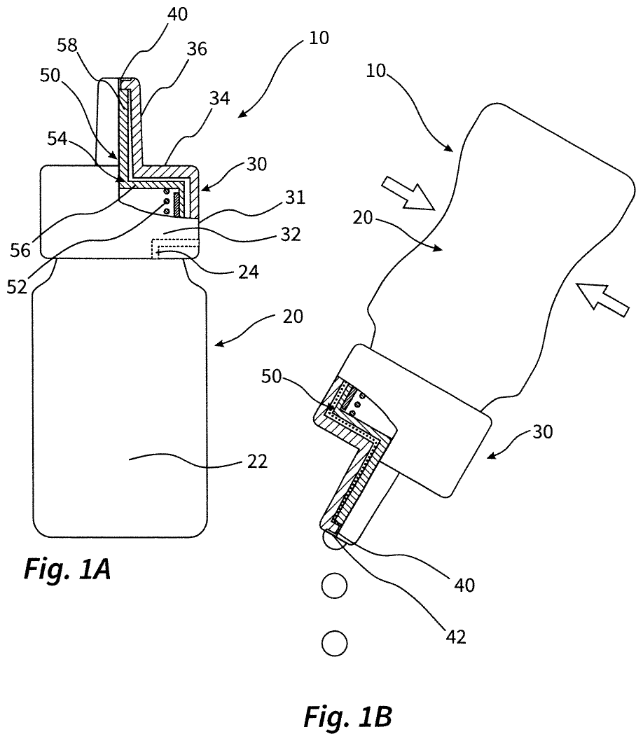

FIGS. 1A and 1B show a liquid dispenser 10 which by way of example is designed as a droplet dispenser. The ventilated protective cap, which is provided in a liquid dispenser 10 according to the invention, is not illustrated in FIGS. 1A and 1B.

Liquid dispenser 10 has a liquid reservoir 22 which is provided within a bottle body 20. A delivery head 30 having a delivery opening 40 is fastened to the bottle body 20, for example by means of a snap-fit connection or a threaded connection.

Delivery head 30 possesses a cylindrical base 31 on which is provided an applicator neck 36 on the distal side of said base 31 that faces away from the bottle body 20. An approximately flat annular face 34, which surrounds the applicator neck 36, is provided on the outside of the applicator neck 36.

A delivery valve 50 is provided within the delivery head. Said delivery valve 50 has a valve body 54 which is impinged with a force by means of a spring 52 and which possesses a valve plate 56 and a valve pin 58 which extends from the latter into the applicator neck 36. In a resting state of the delivery valve 50 the latter is closed because the spring 52 pushes the valve pin from the inside against the end face of the applicator neck 36, as a result closing the delivery opening 40.

The liquid dispenser 10, which is illustrated by way of example in the exemplary embodiments, is a droplet dispenser. The use of this droplet dispenser takes place in an alignment in which the delivery opening 40 points downward or obliquely downward. In this orientation illustrated in FIG. 1B, the bottle body 20 designed as a squeeze bottle is compressed, as is highlighted by the arrows in FIG. 1B. The pressure in the bottle body 20 increases as a result. The increased pressure opens the delivery valve 50 so that liquid can exit through the delivery opening 40.

Provided behind the delivery opening 40 is a droplet-forming geometry 42, presently a droplet-forming face, which is terminated toward the outside by a breakaway edge. The delivered liquid accumulates on this droplet-forming face and forms a droplet which is released from the droplet-forming geometry 42 as soon as said droplet is so heavy that it can longer be held on the droplet-forming face.

Liquid remnants usually remain in the region of the delivery opening 40 after the liquid dispenser has been used. In particular in the case of liquid dispensers having a delivery valve 50, it is not possible to suction this liquid back into the delivery head 30. In order for rapid drying of the liquid remnants, and thus a reduction of the risk of contamination and rapid bacteria growth, not to be countered by a protective cap, a protective cap which is provided with at least one ventilation opening is used in a liquid dispenser of this type.

Indicated in FIG. 1A is a ventilation duct 24 through which ambient air can be inducted into the liquid reservoir for replenishment after a delivery.

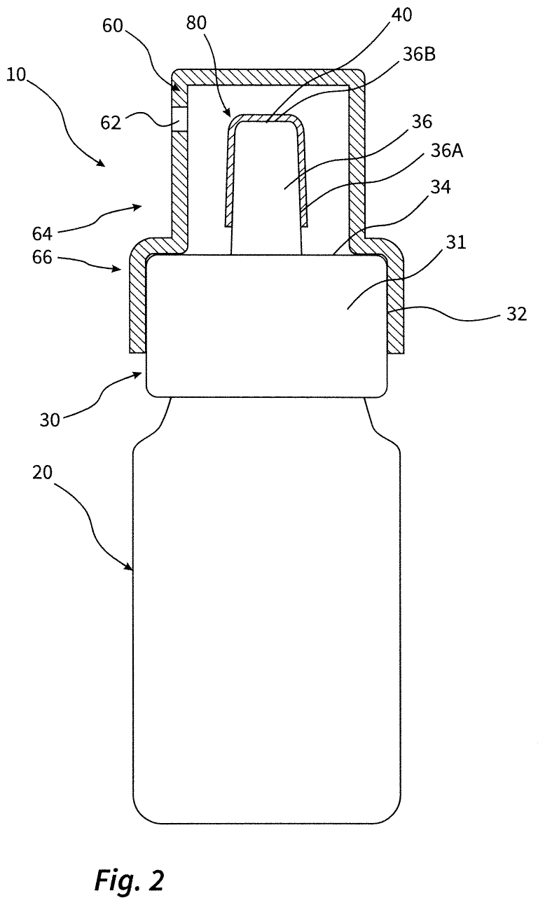

FIG. 2 shows a first design of the liquid dispenser having a protective cap 60 and a removable closure element 80.

The protective cap 60 has a basic shape which is rotationally symmetrical at least in portions. The lower part thereof is formed by a coupling portion 64, the internal diameter thereof being adapted to the external diameter of the base 31 in such a manner that the protective cap 60 is held in a clamping manner after being attached. Provided on the upper end of the coupling portion 64 is a step where the protective cap 60 tapers and transitions into the casing portion 66. This casing portion 66, like the coupling portion, has a substantially consistent or only slightly tapering internal cross section and surrounds the applicator neck 36.

The protective cap is penetrated by at least one ventilation opening 62. This ventilation opening 62 is presently provided in the shell face of the casing portion 66. Ambient air can flow into the cap interior through the ventilation opening, and can accelerate the drying of the delivery opening 40 and the droplet-forming geometry 42 after use of the liquid dispenser 10.

However, the applicator neck 36 in the shipping state of FIG. 2 is still surrounded by a tubular casing of an elastic material, for example of latex or a TPE. This casing forms an additional closure element 80 which prior to removal insulates the cap interior in relation to the delivery opening 40. Therefore, bacteria ingressing through the ventilation opening 62 cannot lead to any contamination of the delivery opening 40 and of the upper part of the applicator neck.

The closure element 80 in the form of the casing can be applied to the applicator neck 36 during the production of the delivery head 30 in that said applicator neck 36 is guided into a dipping bath in an orientation in which the delivery opening 40 is oriented downward. The material forming the casing adheres to the applicator neck 36 and solidifies when the latter is extracted from the dipping bath. An application by spraying is also possible.

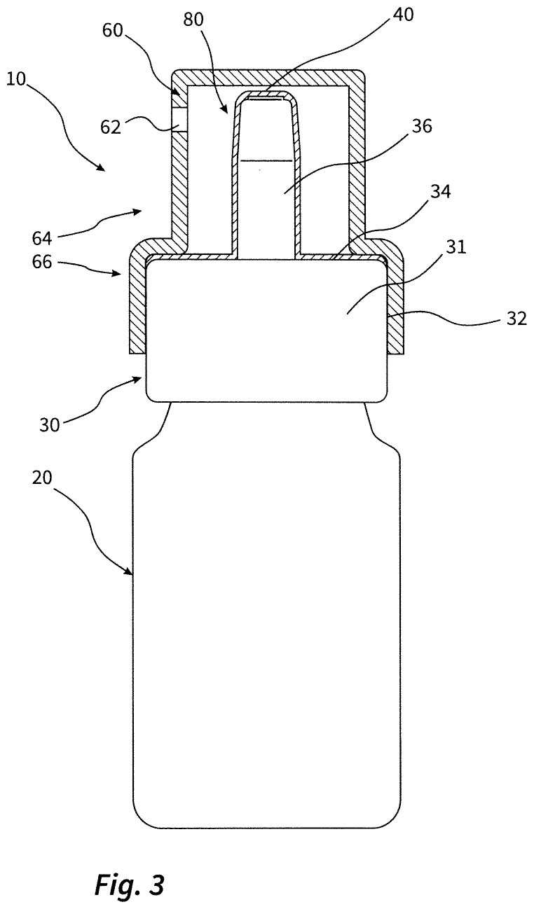

In the design according to FIG. 3, a closure element 80 in the form of a casing of the applicator neck 36 is likewise provided within the protective cap 60. In this design, the applicator neck is of an even slimmer design and has a completely cylindrical sub-portion. It is particularly positively guaranteed by this completely cylindrical sub-portion that the casing is not separated from the applicator neck 36 in a self-acting manner and without an impingement with an external force. Furthermore, in the design of FIG. 3, the casing as the closure element 80 protrudes into the region of the base 31 and covers the annular face 34 in such a way that the peripheral region of the latter is additionally fixed by the protective cap 60. The shape of the applicator neck 36 of FIG. 3 can advantageously also be used in the other exemplary embodiments illustrated here.

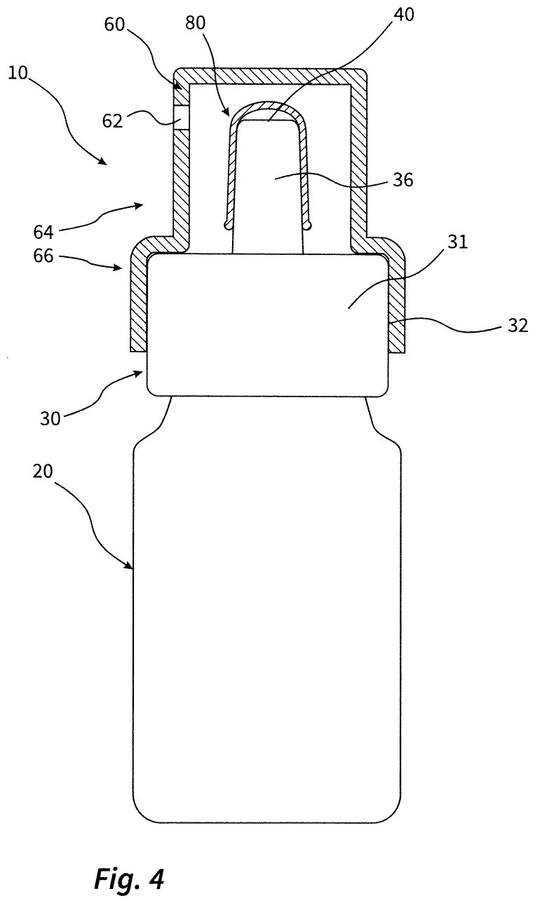

A closure element 80 in the form of a tubular casing, which insulates the delivery opening 40 in relation to the surrounding cap interior, is likewise used in the design of FIG. 4. However, this casing of FIG. 4 is not applied by a dipping or spraying procedure but is separately produced, and has been pushed onto the applicator neck 36 in the course of the production of the dispenser.

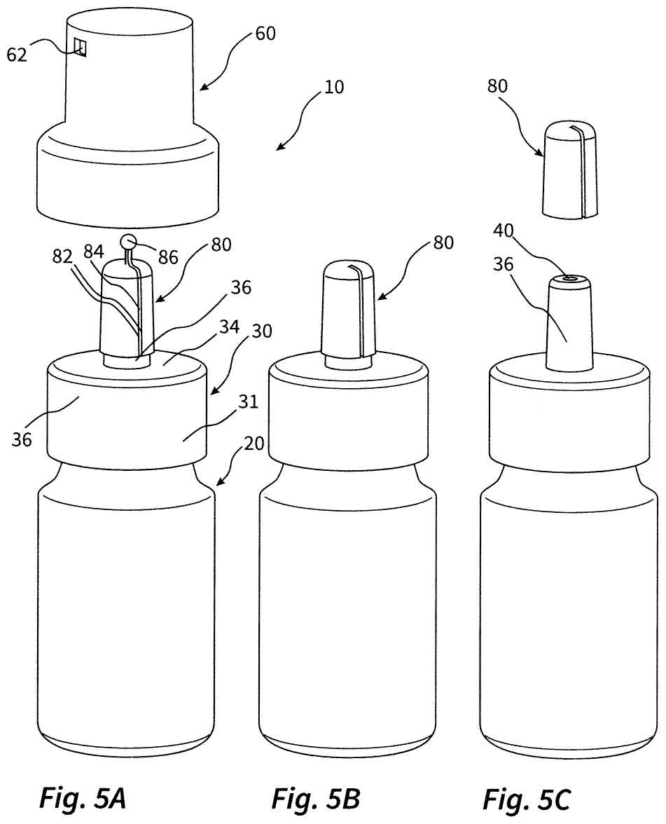

A tubular casing as the closure element 80 is also provided on the applicator neck 36 in the design of FIGS. 5A to 5C. Whilst it is provided in the casings of FIGS. 2 to 4 that the casing as an entity is removed without being mandatorily destroyed for this purpose, it is provided in the design of FIG. 5 that the casing according to the intended use is destroyed for the purpose of removal. For this purpose, said casing has two parallel predetermined breaking lines 82 which are provided on both sides of an opening strip 84. The opening strip 84 transitions into a gripping portion 86. Once the user has removed the protective cap 60, the user grips the gripping portion 86 and pulls the latter in such a way that said user as a result removes the opening strip 84 and thus irreversibly opens the closure element 80.

It is advantageous in this type of design that the user cannot erroneously move the closure element 80 back to its initial position after using the liquid dispenser 10. Whilst this is possible in the designs of FIGS. 2 to 4 and would potentially facilitate the growth of bacteria, it is obvious to the user in the design of FIGS. 5A to 5C that re-attaching closure element 80 cannot be intended. Even when the user re-attaches the laterally opened casing to the applicator neck 36, insulation of the delivery opening 40 is no longer achieved in this way.

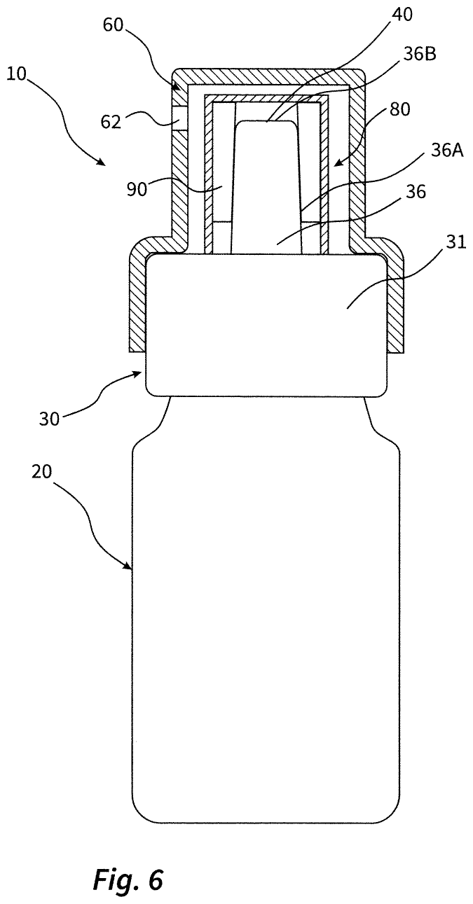

Provided in the design of FIG. 6 is an additional cap as an additional closure element 80 instead of an elastic and tightly fitting casing. This additional cap seals an interior of the additional cap, or at least the delivery opening 40 per se, in relation to the remaining cap interior of the protective cap 60, so that ambient air which flows in through the ventilation openings 62 cannot make its way to the delivery opening 40 in the shipping state. The sealing of the additional cap in relation to the outside can be provided on the lower periphery of the additional cap, by way of which the additional cap rests on the annular face. However, sealing can also be performed in the region of the shell face 36A of the applicator neck 36, or on the end face 36B of the latter.

In the case of the design of FIG. 6, fixing the additional cap is performed by means of clamping ribs 90 on the inside, which rest in a clamping manner on the shell face 36A of the applicator neck 36.

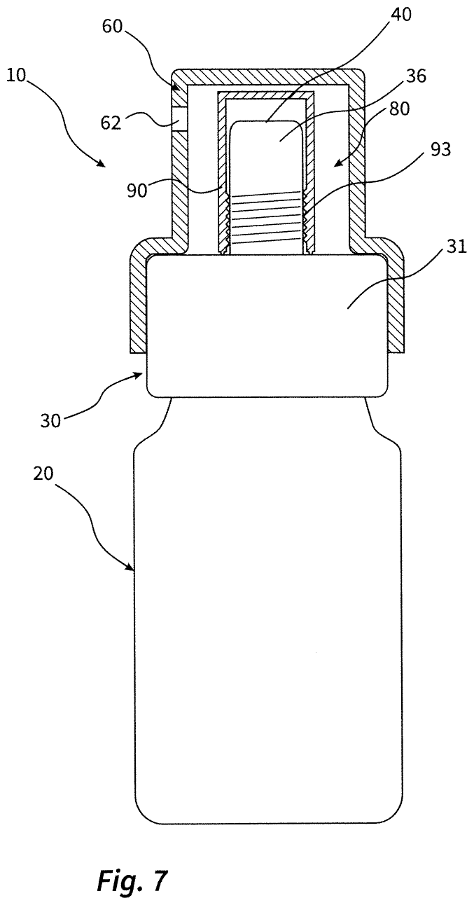

An additional cap is also provided as a closure element 80 in the design of FIG. 7. This additional cap likewise insulates the delivery opening in relation to that part of the cap interior of the protective cap 60 that surrounds the additional cap. Fastening the additional cap to the applicator neck in the case of this design embodiment is performed by an internal thread 93 on the internal side of the additional cap.

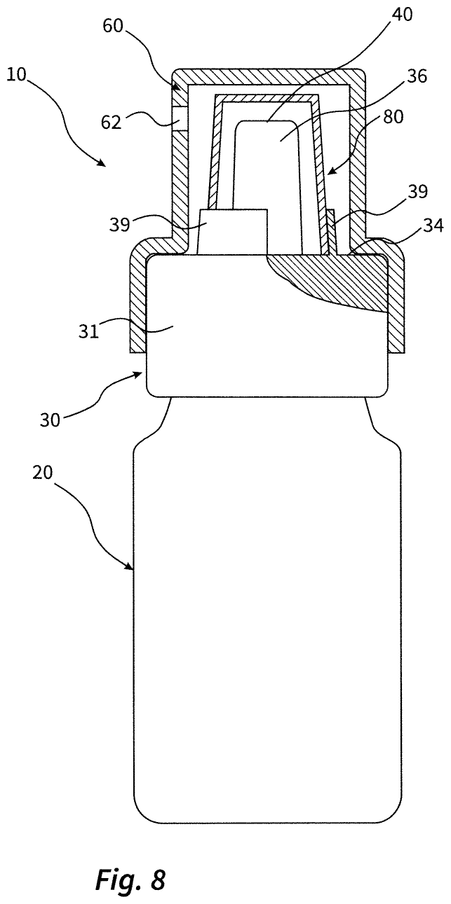

In the design of FIG. 8, a holding structure in the form of a holding collar 39 is provided on the annular face of the base 31 which is illustrated in a partially sectional view. The closure element 80 in the form of an additional cap is inserted into this holding collar 39, and conjointly with the latter forms an undercut in such a way that the additional cap cannot slide out of the holding collar 39. In order to remove the additional cap, the latter has to be radially compressed and extracted from the holding collar 39 in this state.

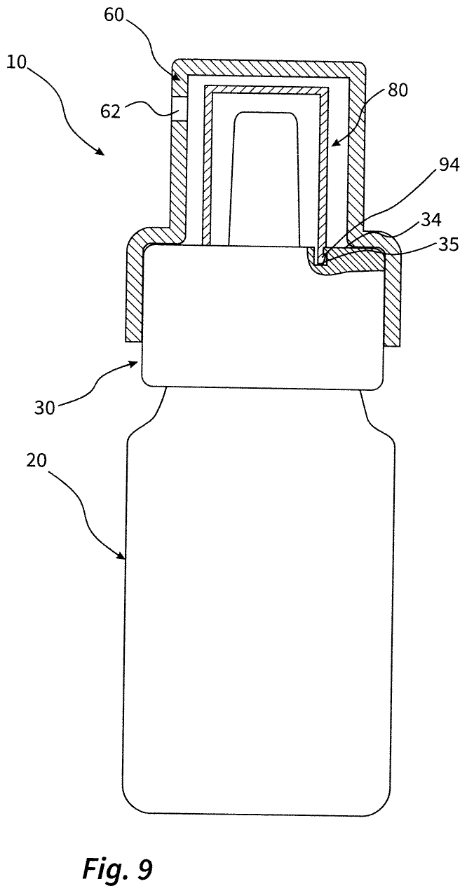

A similar concept has been implemented in the case of the design of FIG. 9. A plurality of clearances 35 are provided in the annular face 34 here. The additional cap, which is provided as an additional closure element 80, on a lower periphery has corresponding hook elements 94 which engage in the clearances 35 and snap into the latter. As in the design of FIG. 8, the additional cap has to be compressed or otherwise deformed in order to be removed.

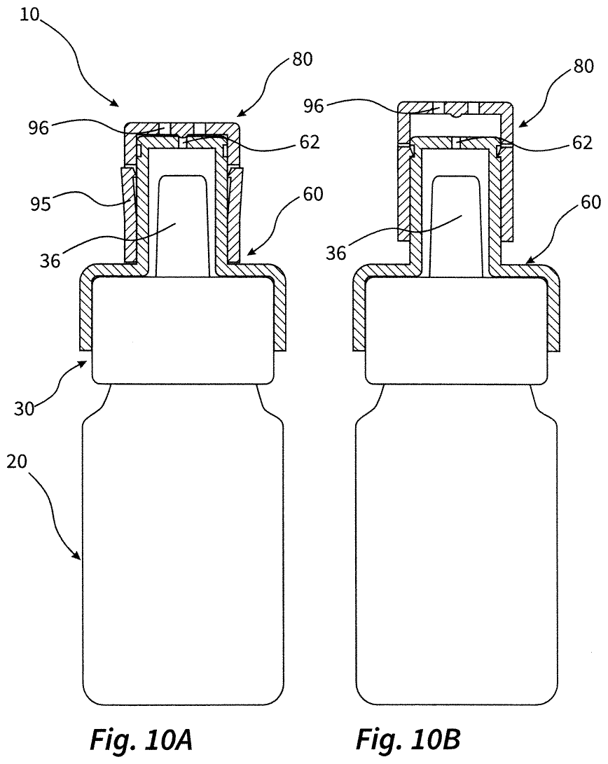

A significantly different concept has been implemented in the design of FIGS. 10A and 10B. The closure element 80 here is designed in the form of a captive add-on cap which is pushed onto the actual protective cap 60 in the region of the casing portion 66. The ventilation opening 62 is disposed in such a manner that in the displaced position of the closure element 80 in the shipping state said ventilation opening 62 is closed by the closure element 80, as is illustrated in FIG. 10A. It is only when the user displaces the add-on cap upwards and as a result removes a closing portion from the ventilation opening 62 that the latter is opened. As from this moment, ambient air can flow into the interior of the protective cap 60 through the ventilation openings 96 in the add-on cap and through the ventilation openings 62 of the protective cap 60, and enable rapid drying of liquid remnants herein.

The protective cap 60 and the add-on cap are preferably designed to suppress a return movement of the add-on cap to the closing state. In the exemplary embodiment, this is achieved by snap-fit elements 95 which latch onto the protective cap 60 in the opened state of the ventilation opening 62.

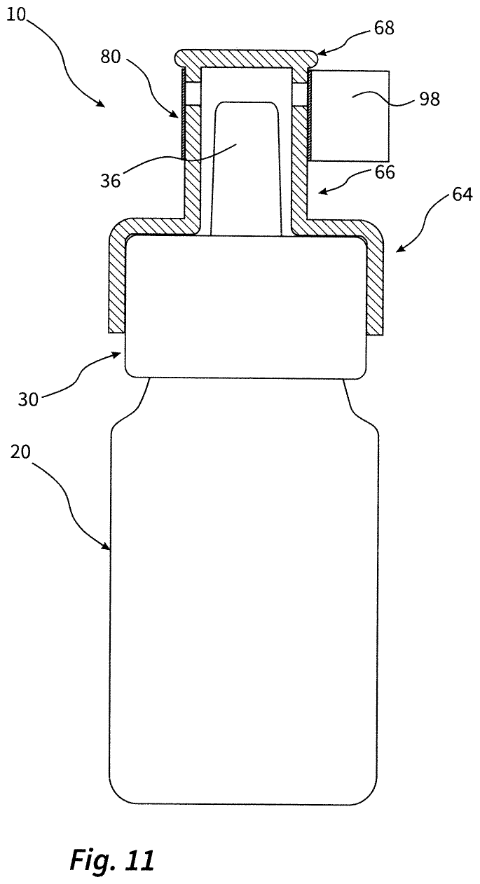

In the design of FIG. 11 it is provided that one or a plurality of ventilation openings 62 are provided in the region of the shell face of the casing portion 66, said ventilation openings 62 in the shipping state illustrated being closed by means of an adhesive tape as an additional closure element 80. The adhesive tape at its end transitions into a gripping portion 98 which extends radially outward. The latter preferably does not protrude beyond the coupling portion 64 in the radial direction, and therefore does not enlarge the external diameter of the liquid dispenser 10.

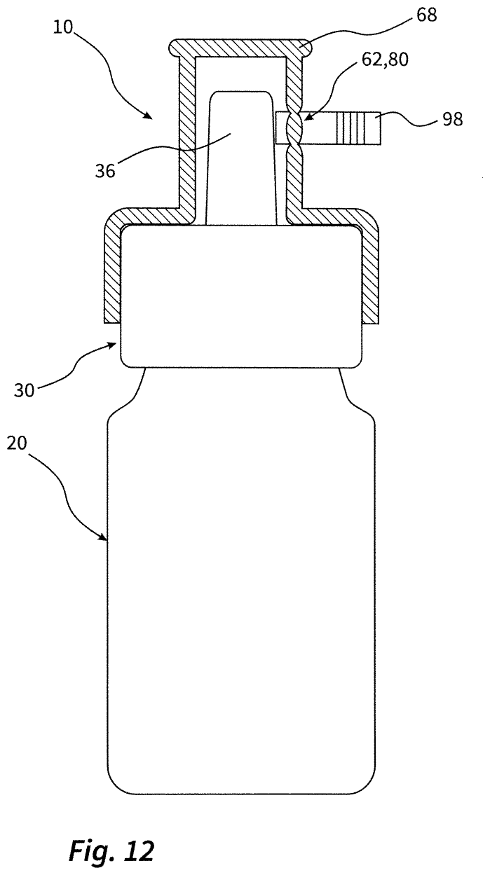

In the design of FIG. 12, the closure element 80 is an integral part of the protective cap 60 per se. The latter is still completely closed in the shipping state. However, the ventilation openings 62 are already prepared in that the closure element 80 is surrounded by thin-walled wall regions. As soon as the user pulls the gripping portion 98, the material tears in the region of the thin-walled wall region in such a way that the ventilation opening 62 is opened and the ventilation path to the delivery opening 40 is opened in this way.

In the designs described the ventilation openings 62 are illustrated as simple cutouts of the cap body of the protective cap 60. However, it is advantageous for a sterile filter with a separation limit of 0.3 μm or less to be additionally provided on the internal side of the ventilation openings 62, ingressing air being filtered by said sterile filter.

1. A liquid dispenser comprising:
a liquid reservoir for receiving liquid;
a bottle body surrounding the liquid reservoir;
a delivery head fastened to the bottle body, the delivery head having a delivery opening;
a protective cap attachable to the delivery head,
the protective cap having at least one ventilation opening and a cap interior, ambient air being flowable into the cap interior through the at least one ventilation opening when the protective cap is in an attached state; and
a removable closure element having a shipping state preventing ambient air from making its way through the at least one ventilation opening to the delivery opening;
wherein the delivery head has a substantially flat upper annular face and an applicator neck having an outside, the annular face surrounding the applicator neck and the protective cap being is held in a form-fitting or force-fitting manner on the outside of the applicator neck in the attached state,
the applicator neck having an elongate shape with a substantially cylindrical shell face and an end face penetrated by the delivery opening.

2. The liquid dispenser as claimed in claim 1, wherein the delivery head has a shell region adjoining the annular face,
the protective cap has a coupling portion with an internal cross section at least as large as an external contour of the annular face, the internal cross section of the coupling portion in the attached state resting on the shell region,
the protective cap has a casing portion adjoining the coupling portion and having an internal cross section tapering in a stepped manner relative to the coupling portion, the applicator neck in the attached state of the protective cap being disposed within the casing portion.

3. The liquid dispenser as claimed in claim 2, wherein
the at least one ventilation opening penetrates the casing portion.

4. The liquid dispenser as claimed in claim 1, wherein
the closure element comprise tear-off element integral with the protective cap, the tear-off element in the shipping state being connected in a materially integral manner to a periphery surrounding the at least one ventilation opening and, for opening the at least one ventilation opening, being removable from the protective cap by a tensile force.

5. The liquid dispenser as claimed in claim 1, wherein
the closure element comprises an adhesive tape applied to the protective cap, the adhesive tape in the shipping state covering the at least one ventilation opening.

6. The liquid dispenser as claimed in claim 1, wherein
the closure element comprises an additional cap disposed in a cap interior of the protective cap and covering the delivery opening.

7. The liquid dispenser as claimed in claim 6, wherein
the additional cap in the shipping state is connected to the delivery head in a force-fitting or form-fitting manner by a coupling structure.

8. The liquid dispenser as claimed in claim 1, wherein
the protective cap has a displaceable or rotatable segment forming the closure element, the closure element being movable between a closing position that closes the at least one ventilation opening and a releasing position that releases the at least one ventilation opening.

9. The liquid dispenser as claimed in claim 1,
further including a tubular casing forming the closure element, the applicator neck in the shipping state being surrounded by the tubular casing.

10. The liquid dispenser as claimed in claim 1, further including a substantially cylindrical shell face,
the applicator neck in the shipping state being surrounded at least in a region of the delivery opening and in a region of the substantially cylindrical shell face by a layer of a lacquer forming the closure element, a plastics material forming the closure element or a wax forming the closure element.

11. The liquid dispenser as claimed in claim 1; including at least one of the following:
the liquid dispenser is configured as a droplet dispenser and has a droplet-forming geometry disposed on an end face of the applicator neck, the droplet-forming geometry having an annular droplet-forming face including a breakaway edge configured to delimit the annular droplet-forming face on an outside; and/or
the bottle body is configured as a collapsible squeeze bottle body.

12. The liquid dispenser as claimed in claim 1, further including at least one of the following:
the applicator neck projects above the annular face by at least 9 mm; and/or
external diameter of the annular face is between 15 mm and 20 mm; and/or
a maximum external diameter of the applicator neck is 8 mm or less; and/or
a maximum external diameter of the applicator neck is at most 40% of the external diameter of the annular face.

13. The liquid dispenser as claimed in claim 1, further including at least one of the following:
the applicator neck comprises a polyolefin; and/or
a casing surrounding the applicator neck in the shipping state comprises polyurethane, polyvinylchloride, polyethylene, or a thermoplastic elastomer.

14. The liquid dispenser as claimed in claim 1, further including at least one of the following:
the liquid reservoir has an internal volume of less than 20 ml; and/or
the liquid reservoir is filled with a pharmaceutical liquid.

15. The liquid dispenser as claimed in claim 1, further including at least one of the following:
the delivery head has a liquid duct connecting the liquid reservoir to the delivery opening; and/or
a delivery valve is disposed in the liquid duct and opens as a function of pressure; and/or
the delivery valve comprises a valve body having a valve plate and a valve pin projecting from the valve plate, the valve plate being disposed below the annular face of the delivery head, and the valve pin extends into the applicator neck.

16. The liquid dispenser as claimed in claim 2, further including at least one of the following:
the internal cross section of the coupling portion has a round shape or an elliptic shape; and/or
the protective cap has a terminating portion with an external contour, the external contour being enlarged relative to the casing portion and adjoining a distal end of the casing portion.

17. The liquid dispenser as claimed in claim 5, wherein the adhesive tape is applied to the protective cap so as to circumferentially surround the protective cap in a region of a casing portion of the protective cap.

18. The liquid dispenser as claimed in claim 6, further including one or more of the following:
the additional cap is held on a shell face of the applicator neck in a force-fitting manner by clamping ribs on an internal side of the additional cap; or
the additional cap is held on a shell face of the applicator neck in a form-fitting manner by an internal thread disposed on an internal side of the additional cap.

19. The liquid dispenser as claimed in claim 7, wherein the annular face includes one or more of the following:
clearances, the coupling structure engaging in the clearances; and/or
holding structures forming undercuts.

20. The liquid dispenser as claimed in claim 8, further including one or more of the following:
the displaceable or rotatable segment is guided on an outside on a casing portion; and/or
the displaceable or rotatable segment and the protective cap have latching means for securing the releasing position of the displaceable or rotatable segment.

21. The liquid dispenser as claimed in claim 9, further including one or more of the following:
the tubular casing is made of an elastic plastics material; and/or
the tubular casing has at least one predetermined breaking line, or two predetermined breaking lines and a detachable opening strip disposed between the two predetermined breaking lines.
